(19) United States
(12) Patent Application Publication
(10) Pub. No.: US 2024/0421404 A1
(43) Pub. Date: Dec. 19, 2024

(54) Rechargeable battery having a spring-loaded connection apparatus

(71) Applicant: Hilti Aktiengesellschaft, Schaan (LI)

(72) Inventors: Florian MAYR, Kaufbeuren (DE); Markus HARTMANN, Mauerstetten (DE); Klaus HAUSER, Schwabmuenchen (DE); Uwe HAINKE, Dresden (DE)

(21) Appl. No.: 18/706,794

(22) PCT Filed: Nov. 15, 2022
(86) PCT No.: PCT/EP2022/081907

§ 371 Date: May 2, 2024

(30) Foreign Application Priority Data
Dec. 1, 2021 (EP) 21211583.6

(51) Int. Cl. H01M 50/247; B25F 5/00; H01R 13/631

(52) U.S. Cl. CPC H01M 50/247; B25F 5/006; H01R 13/6315; H01M 2220/30

(57) ABSTRACT

A rechargeable battery, preferably as a releasable energy supply for a power tool, comprising at least one energy storage cell and a connection apparatus for releasably connecting the rechargeable battery to a power tool, the connection apparatus comprising at least one first, second and third connection element. The connection apparatus includes a holding and receiving apparatus for at least partially receiving the first, second and third connection elements, wherein the first and second connection elements are connected to the holding and receiving apparatus by at least one compensating element in such a way that a relative movement in at least one direction between the first and second connection element and the holding and receiving apparatus can be compensated for, and wherein the first and second connection elements are connected to the third connection element in such a way that a relative movement in at least one direction between the third connection element and the holding and receiving apparatus can be compensated for.

The present invention relates to a rechargeable battery, preferably as a releasable energy supply for a power tool, comprising at least one energy storage cell and a connection apparatus for releasably connecting the rechargeable battery to a power tool, the connection apparatus comprising at least one first, second and third connection element.

### BACKGROUND

So-called cordless power tools, for example cordless screwdrivers, drills, saws and grinding machines, or the like, may be connected to one or more rechargeable batteries for power-supply purposes. In this case, the rechargeable battery has a plurality of energy storage cells, also known as accumulator cells, by means of which electrical energy may be received, stored and released again. If the rechargeable battery is connected to a power tool, the electrical energy stored in the energy storage cells may be fed to the consumers (e.g. a brushless electric motor) of the power tool. For charging purposes, i.e. for charging the energy storage cells with electrical energy, the rechargeable battery is connected to a charging apparatus so that electrical energy can enter the energy storage cells.

### SUMMARY OF THE INVENTION

When using or working with a battery-operated power tool, significant vibrations and shocks may occur in the power tool and in the rechargeable battery connected to the power tool. This is especially the case if the power tool is a demolition tool, e.g. a chipping or demolition hammer. As a result of the vibrations and shocks, virtually all components and assemblies of the power tool and of the rechargeable battery are subject to loads of varying degrees during the use of the power tool. These loads may ultimately result in damage to the respective components or even in a total failure of the power tool as a whole.

However, a particular problem is the interface between the power tool and the rechargeable battery. At the interface, the electrical contacts of the power tool and the electrical contacts of the rechargeable battery are connected to one another such that the electrical energy stored in the energy storage cells may make its way from the rechargeable battery to the power tool. As a result of the rechargeable battery merely being in releasable contact with the power tool via the interface, the respective electrical contacts of the power tool and of the rechargeable battery abut against one another with force fit. In this case, such force-fitting connections usually consist of a spring-mounted clip (i.e. female contact) and an insertion element (i.e. male contact), which can be inserted into the clip.

The vibrations and shocks in the power tool and in the rechargeable battery connected to the power tool may result in a relative movement and even in an actual break in the contact connection. The relative movement should be prevented since it may lead to wear or premature deterioration of the contacts. A break in the contact connection may result in undesired sparking or even an arc at the contacts.

A vibration- and shock-proof connection of the respective electrical contacts would be advantageous.

An object of the present invention-is to provide a battery interface for a rechargeable battery, preferably as a releasable energy supply for a power tool, having a connection apparatus, which has at least one first, second and third connection element, by means of which the above-mentioned problem may be solved and a vibration-and shock-proof connection may be achieved.

The present invention provides a rechargeable battery, preferably as a releasable energy supply for a power tool, comprising at least one energy storage cell and a connection apparatus for releasably connecting the rechargeable battery to a power tool, the connection apparatus comprising at least one first, second and third connection element.

According to the invention, it is provided that the connection apparatus comprises a holding and receiving apparatus for at least partially receiving the first, second and third connection elements, wherein the first and second connection elements are connected to the holding and receiving apparatus by at least one compensating element in such a way that a relative movement in at least one direction between the first and second connection element and the holding and receiving apparatus can be compensated for, and wherein the first and second connection elements are connected to the third connection element in such a way that a relative movement in at least one direction between the third connection element and the holding and receiving apparatus can be compensated for.

It is thus possible to easily compensate vibrations and shocks which act on the connection elements and may result in a relative movement and even an actual break in the contact connection between the rechargeable battery and the power tool.

According to an advantageous embodiment of the present invention, it may therefore be provided that the holding and receiving apparatus contains at least one first and second substantially elongate chamber into which the first and second connection elements can each be positioned with an associated compensating element such that the first and second connection elements are movable reversibly in a direction relative to the respective chamber by means of the associated compensating element.

A chamber may in this case receive more than a single connection element. A first chamber can thus, for example, contain two or more than two connection elements configured as positive poles. Accordingly, a second chamber can also contain two or more than two connection elements configured as negative poles and a third chamber can contain two or more than two connection elements configured as communication elements. According to alternative embodiments, it may be possible for each chamber to be configured in the form of a frame, without continuous or closed side walls.

In this case, the compensating element may be configured in the form of a spring, and in particular a spiral spring. Alternatively, the compensating element may be configured as a component with an elastically deformable material. An elastomer is also a possible material in this case. It is thus possible to easily counteract a vibration-related movement of the connection element in multiple directions, i.e. not only in the direction towards or away from the connection element.

According to a further advantageous embodiment of the present invention, it may be provided for at least two chambers to be arranged offset from one another, in at least one plane, on the holding and receiving apparatus.

It is thus possible to reduce a mechanical resistance, which may arise if too many connection elements, located on one plane, are to be brought into simultaneous contact with corresponding contact elements of a power tool or a charging device. As a result of the offset arrangement, a first number of connection elements of the rechargeable battery may firstly be brought into contact with corresponding connecting elements of a power tool or a charging device and then a second number of connection elements of the rechargeable battery may subsequently be brought into contact with corresponding connecting elements of a power tool or a charging device.

According to an advantageous embodiment of the present invention, it may therefore be provided for the connecting elements of the power tool or a charging device to be configured in the form of pin-like plugs and the connection elements of the battery interface to be configured in the form of clips with elastically deformable plates for receiving pin-like plugs. The pin-like plugs may also be referred to as blades.

### BRIEF DESCRIPTION OF THE DRAWINGS

Further advantages will become apparent from the following description of the figures. Various exemplary embodiments of the present invention are illustrated in the figures.

The figures, the description and the claims contain numerous features in combination. A person skilled in the art will expediently also consider the features individually and combine them to produce useful further combinations.

In the figures:

FIG. 1 shows a side view of a power tool according to the invention comprising a rechargeable battery which is connected to the power tool;

FIG. 2 shows a further side view of the power tool according to the invention comprising a rechargeable battery which is disconnected from the power tool;

FIG. 3 shows a perspective detail view of an interface apparatus of the power tool;

FIG. 4 shows a side view of the rechargeable battery with a connection apparatus;

FIG. 5 shows a plan view of the connection apparatus of the rechargeable battery according to the first embodiment;

FIG. 6 shows a perspective view of the connection apparatus of the rechargeable battery according to the first embodiment; and

FIG. 7 shows a perspective view of the connection apparatus of the rechargeable battery according to a second embodiment.

### DETAILED DESCRIPTION

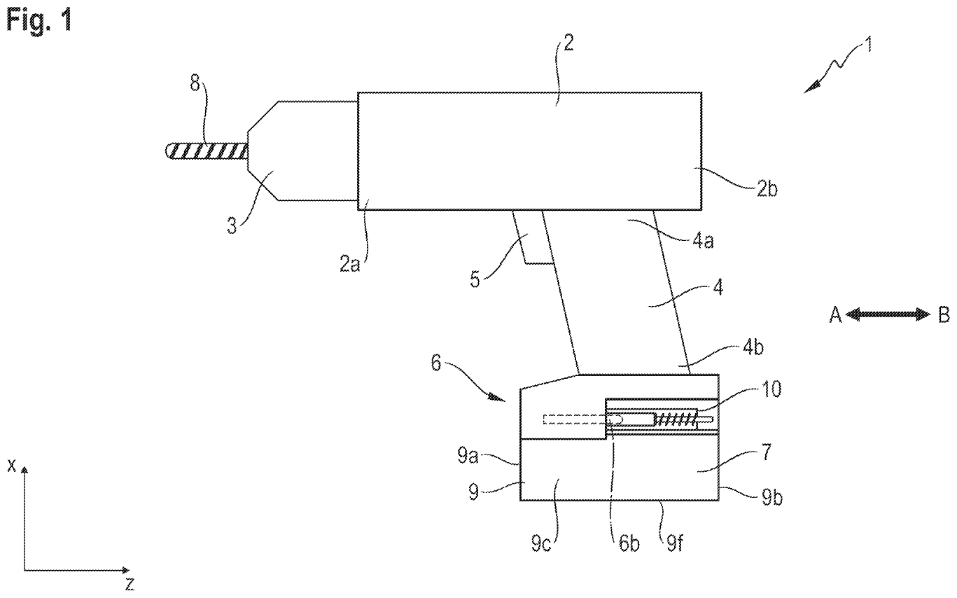

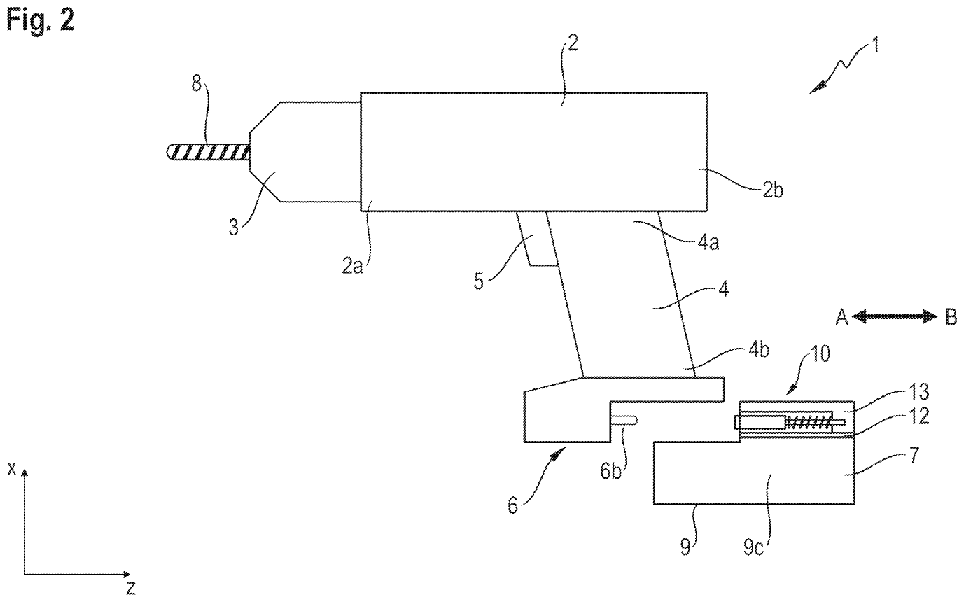

An exemplary embodiment of a power tool 1 is illustrated in FIGS. 1 and 2.

The power tool 1 in this case is configured in the form of a drill. However, it is also possible that the power tool 1 is a hammer drill, a circular saw, a grinding tool or the like.

The power tool 1 illustrated in FIGS. 1 and 2 comprises substantially one housing 2, one tool fitting 3, and a handle 4 having an activation switch 5. The power tool 1 furthermore comprises an interface apparatus 6 for a rechargeable battery 7.

In FIG. 1, a state is shown in which the rechargeable battery 7 is connected to the power tool 1. To this end, the rechargeable battery 7 is pushed onto the interface apparatus 6 in arrow direction A. As shown in FIG. 2, the rechargeable battery 7 may be removed from the interface apparatus 6 again, and therefore from the power tool 1, according to arrow direction B. If the rechargeable battery 7 is connected to the power tool 1, electrical energy may make its way from the rechargeable battery 7 to the power tool 1.

The housing 2 of the power tool 1 has a first end 2a and a second end 2b. The tool fitting 3 is positioned at a first end 2a of the housing 2. The tool fitting 3 serves to receive and releasably hold a tool 8. The tool 8 shown in FIGS. 1 and 2 is configured in the form of a drill.

An electric motor for generating a torque is positioned in the interior of the housing 2. The electric motor is therefore an electric consumer of electrical energy. The torque generated in the electric motor is transmitted to the tool fitting 3 via an output shaft and a gear system. The tool 8 is rotated by means of the transmitted torque.

The handle 4 comprises the activation switch 5, a first end 4a and a second end 4b. The activation switch 5 serves for a user to actuate or activate the power tool 1.

The first end 4a of the handle 4 is secured to a second end 2b of and underneath the housing 2.

The interface apparatus 6 for releasable connection of the rechargeable battery 7 is positioned at the second end 4b of the handle 4. According to a first embodiment, the interface apparatus 6 comprises a first, second and third connecting element 6a, 6b, 6c.

Alternatively and according to further embodiments, the interface apparatus 6 may also comprise more or fewer than a first, second and third connecting element.

According to the first embodiment, the first connecting element 6a is configured as a positive pole, the second connecting element 6b is configured as a negative pole and the third connecting element 6c is configured as a communication element. By configuring the first connecting element 6a as a positive pole and the second connecting element 6b as a negative pole, an electric circuit between the power tool 1 and the rechargeable battery 7 may be generated or closed for the purpose of supplying electrical energy to the power tool 1. By means of the third connecting element 6c, configured as a communication element, information in the form of data and signals may be received and sent by the power tool 1 so that communication may take place between the power tool 1 and the rechargeable battery 7.

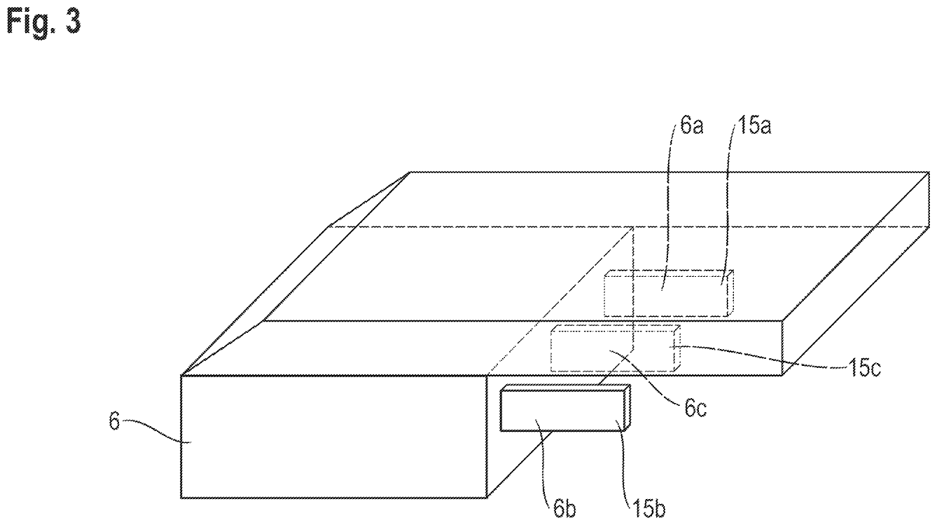

In this case, as shown in FIG. 3, the third connecting element 6c, configured as a communication element, is positioned on the interface apparatus 6 between the first connecting element 6a, configured as a positive pole, and the second connecting element 6b, configured as a negative pole, and therefore substantially in the center of the interface apparatus 6. Alternatively, however, other arrangements of the three or more connecting elements are also possible.

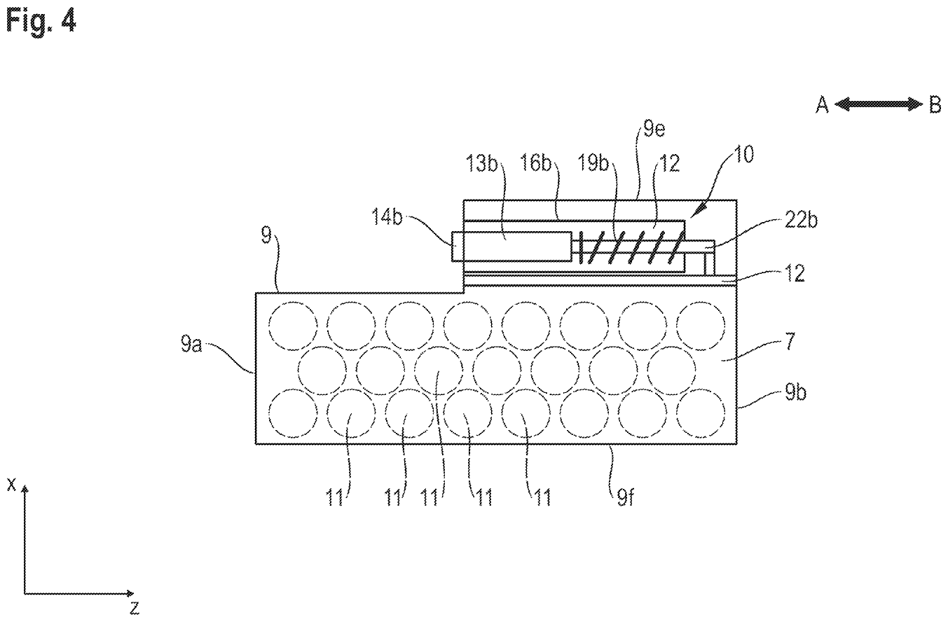

As shown in particular in FIG. 4, the rechargeable battery 7 comprises substantially one battery housing 9. In this case, the battery housing 9 in turn comprises a front side 9a, a rear side 9b, a left-hand side wall 9c, a right-hand side wall, a top side 9e and an underside 9f. Only the left-hand side wall 9c of the battery housing 9 is shown in FIGS. 1 and 2; however, the left-hand and right-hand side wall are substantially identical.

A connection apparatus 10 is positioned on the top side 9e of the battery housing 9. The connection apparatus 10 may also be referred to as a battery interface apparatus.

A number of individual, mutually connected energy storage cells 11, also known as battery cells, are positioned in the interior of the battery housing 9. Moreover, the respective energy storage cells 11 are connected to the connection apparatus 10. Electrical energy may be received and stored in the rechargeable battery 7, and released again, by means of the energy storage cells 11. Neither the connection of the battery cells 11 to one another nor the connection of the battery cells 11 to the connection apparatus 10 are illustrated in the figures.

Furthermore, the rechargeable battery 7 comprises a control apparatus 12 by means of which the functions of the rechargeable battery 7 are controlled and regulated. The functions of the rechargeable battery 7 which may be controlled and regulated by the control apparatus 12 include, for example, regulating the quantity of electrical energy or blocking the release of electrical energy from the energy storage cells 11. The control apparatus 12 of the rechargeable battery 7 is connected to the energy storage cells 11. The connections of the control apparatus 12 to the individual energy storage cells 11 are not indicated in the figures.

In this case, the connection apparatus 10 substantially comprises a holding and receiving apparatus 13 for receiving and holding a first, second and third connection element 13a, 13b, 13c. The first, second and third connection element 13a, 13b, 13c is connected to the control apparatus 12 in each case.

According to the first embodiment, the first connection element 13a is configured as a positive pole, the second connection element 13b is configured as a negative pole and the third connection element 13c is configured as a communication element. According to alternative embodiments, more than three connection elements may be provided so that, for example, a first and second positive pole, a first and second negative pole and a first and second communication element are comprised in the holding and receiving apparatus 13.

As indicated in FIGS. 1 and 2, the first connection element 13a of the rechargeable battery 7, which is configured as a positive pole, serves for releasable connection to the corresponding first connecting element 6a of the power tool 1, which is configured as a positive pole. The second connection element 13b of the rechargeable battery 7, which is configured as a negative pole, in turn serves for releasable connection to the corresponding second connecting element 6b of the power tool 1, which is configured as a negative pole. Furthermore, the third connection element 13c of the rechargeable battery 7, which is configured as a communication element, serves for releasable connection to the corresponding third connecting element 6c of the power tool 1, which is configured as a communication element.

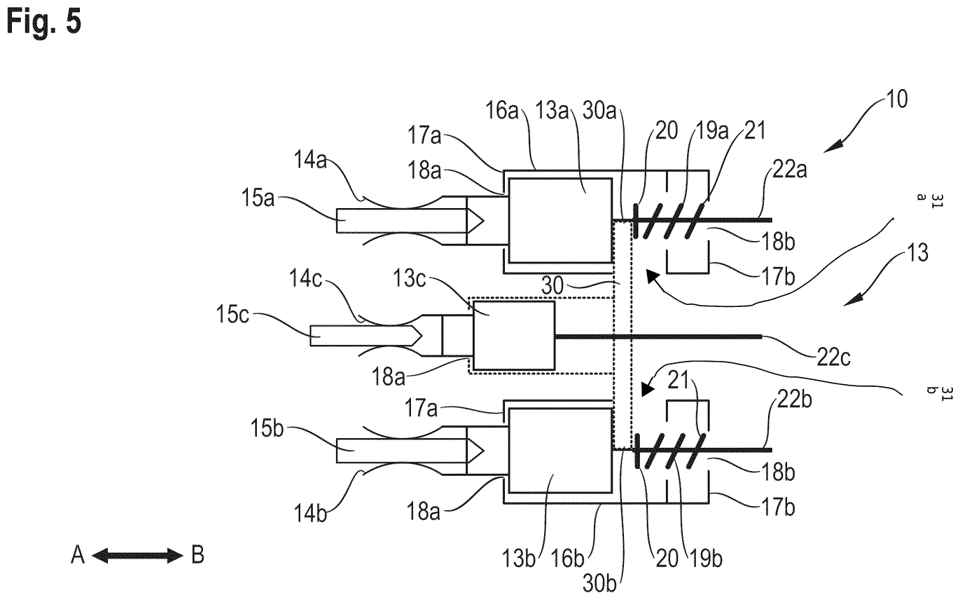

In this case, as shown in particular in FIG. 5, the first, second and third connection element 13a, 13b, 13c of the rechargeable battery 7 each comprise a terminal 14a, 14b, 14c. The terminal may also be referred to as a clip.

The first, second and third connecting element 6a, 6b, 6c of the power tool 1, on the other hand, each comprise a blade 15a, 15b, 15c as a contact. The blade 15a, 15b, 15c may also be configured as an elongated contact pin so that each connecting element 6a, 6b, 6c of the power tool 1 may be received in the corresponding connection element 13a, 13b, 13c of the rechargeable battery 7. A certain spring force of the connection elements 13a, 13b, 13c holds the connecting element 6a, 6b, 6c in a fixed manner and results in it making contact.

The blade may in this case also be referred to as a pin-like plug.

As can also be seen in FIG. 5, the holding and receiving apparatus 13 contains a first and second chamber 16a, 16b. The first chamber 16a serves to receive the connection element 13a and the second chamber 16b serves to receive the connection element 13b. The chamber 16a, 16b may also be referred to as a shaft.

According to alternative embodiments, it may be possible for the chamber to be configured in the form of a frame, without continuous or closed side walls.

Each chamber 16a, 16b in this case has a first end 17a and a second end 17b. At the first end 17a of each chamber 16a, 16b there is a first opening 18a and at the second end 17b of each chamber 16a, 16b there is a second opening 18b.

The opening may also be referred to as a cutout.

The first connection element 13a is positioned in the first chamber 16a and the second connection element 13b in the second chamber 16b. The third connection element 13c is not positioned in a chamber or the connection element 13c is positioned between the chambers 16a, 16b.

As already mentioned above, it may be possible, according to an alternative embodiment, for a chamber to receive more than one connection element. For example, the first chamber 16a can contain two or more than two connection elements configured as positive poles. Accordingly, the second chamber 16b can contain two or more than two connection elements configured as negative poles.

As already indicated above, each chamber 16a, 16b is of substantially elongate design and in this case is longer by a certain distance than the corresponding connection element 13a, 13b positioned in the respective chamber 16a, 16b. The chamber 16a, 16b is configured to be longer so that the connection element 13a, 13b may move in the chamber 16a, 16b in arrow direction A or B. The respective terminal 14a, 14b of a connection element 13a, 13b projects out of the respective chamber 16a, 16b through the first opening 18a at the first end 17a of each chamber 16a, 16b such that the two limbs of each terminal 14a, 14b are freely movable outside the chamber 16a, 16b for the purpose of receiving a blade 15a, 15b of a connecting element 6a, 6b of the power tool, cf. FIG. 5.

Furthermore, the first and second connection elements 13a, 13b each contain a compensating element 19a, 19b.

In the present exemplary embodiment, the compensating element 19a, 19b is configured in the form of a spiral spring and, in particular, as a compression spring.

Alternatively, the compensating element 19a, 19b may also be an elastic block.

In this case, each compensating element 19a, 19b configured as a spring has a first and second end 20, 21. As shown in particular in FIG. 5, the first end 20 of a compensating element 19a, 19b configured as a spring is connected to the respective rear end of a connection element 13a, 13b. The second end 21 of a compensating element 19a, 19b configured as a spring is connected to the respective second end 17b of a chamber 16a, 16b. As a result of the special configuration of the compensating element 19a, 19b as a compression spring, and as a result of being positioned between the second end 17b of a chamber 16a, 16b and the rear end of a connection element 13a, 13b, the connection element 13a, 13b is pressed in arrow direction A.

Moreover, the connection element 13a, 13b may be moved in arrow direction B counter to the spring force of the compensating element. A movement of the connection element 13a, 13b in the arrow direction A or B within the chamber 16a, 16b can occur as a result of vibrations or shocks that act on the rechargeable battery while the power tool is being used.

As can also be seen in FIG. 5, the holding and receiving apparatus 13 contains a connecting element 30 with a first end 30a and a second end 30b. Furthermore, the first chamber 16a has a first aperture 31a and the second chamber 16b has a second lateral aperture 31b. The lateral aperture may also be referred to as an opening or cutout.

The connecting element 30 serves for connecting the three connection elements 13a, 13b, 13c to one another, wherein the first connection element 13a is connected by the connecting element 30 to the third connection element 13c and the third connection element 13c is connected by the connecting element 30 to the second connection element 13b. The connecting element 30 extends here with the first end 30a through the first lateral aperture 31a of the first chamber 16a and with the second end through the second lateral aperture 31b of the respective chamber 16b. The first end 30a of the connecting element 30 is connected to the first connection element 13a and the second end 30b of the connecting element 30 is connected to the second connection element 13b. The center 30c of the connecting element 30 is in turn connected to the third connection element 13c.

Owing to the rigid connection of the three connection elements 13a, 13b, 13c by the connecting element 30, the three connection elements 13a, 13b, 13c move synchronously or simultaneously with one another.

The first, second and third connection element 13a, 13b, 13c comprise a connecting line 22a, 22b, 22c in each case. The connecting line 22a, 22b, 22c serves for connecting the connection elements 13a, 13b, 13c to the control apparatus 12 of the rechargeable battery 7. In the case of the first and second connection element 13a, 13b, the respective connecting line 22a, 22b is configured to conduct an electric current.

The connecting line 22a, 22b of the first and second connection element 13a, 13b may also be referred to as a stranded wire.

In the case of the third connection element 13c, the connecting line 22c is configured to conduct data and information in the form of electrical signals.

As indicated in the figures, the respective connecting line extends through the compensating element configured as a compression spring.

By means of the compensating element 19a, 19b configured as a compression spring, the connection elements 13a, 13b, 13c are pressed in direction A, or in the direction of the connecting elements 6a, 6b, 6c, in a connected state, i.e. when the connection elements 13a, 13b, 13c of the rechargeable battery 7 and the connecting elements 6a, 6b, 6c of the power tool 1 are in contact.

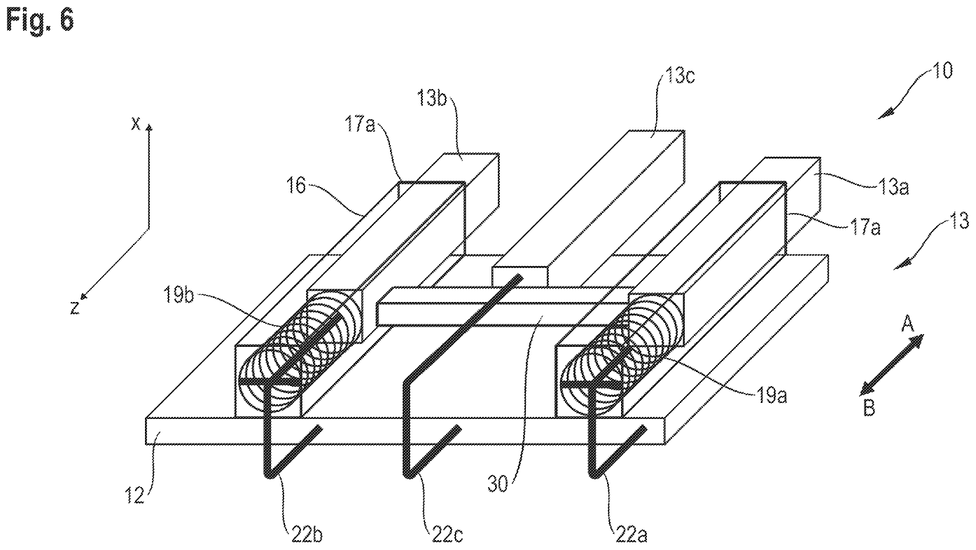

FIG. 6 shows the holding and receiving apparatus 13 according to the first embodiment. The first and second chambers 16a, 16b and the first, second and third connection elements 13a, 13b, 13c are positioned in one plane. The third connection element 13c, however, is arranged offset from the first and second connection element 13a, 13b and from the first and second chamber 16a, 16b in arrow direction A.

As a result of the special mutually offset arrangement of the connection elements 13a, 13b, 13c, the third connection element 13c is firstly connected to the corresponding connecting element 6c of the power tool 1. The first and second connection elements 13a, 13b are then connected to the corresponding first and second connecting element 6a, 6b of the power tool 1. The mechanical resistance when connecting the rechargeable battery 7 to the power tool 1 is lower due to the fact that all three connection elements 13a, 13b, 13c are not connected to the corresponding connecting elements 6a, 6b, 6c at the same time.

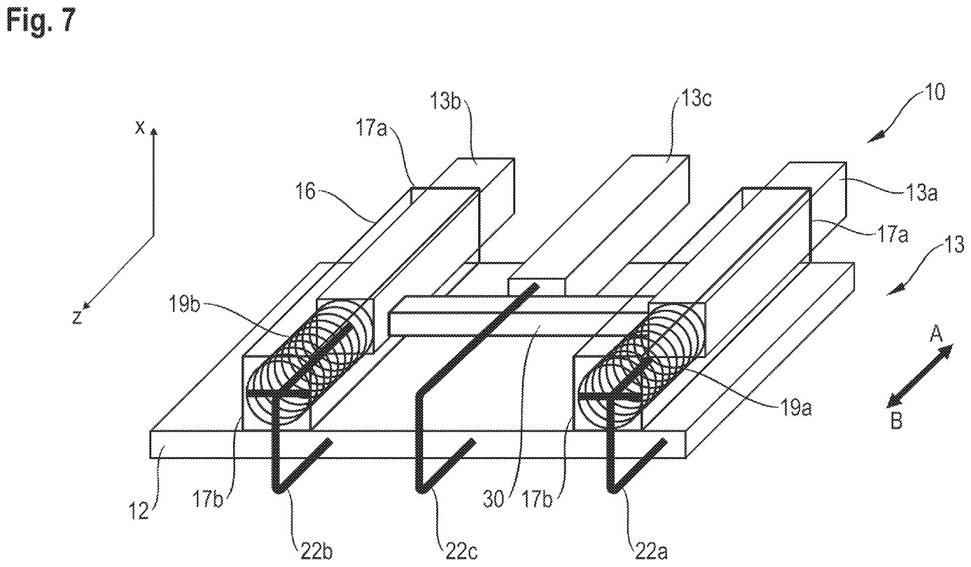

FIG. 7 shows the holding and receiving apparatus 13 according to a second embodiment. As in the first embodiment, the first and second chambers 16a, 16b and the first, second and third connection elements 13a, 13b, 13c are likewise positioned in one plane. However 13c is shorter than 13a and 13b so that the connecting ends of the first, second and third connection elements 13a, 13b, 13c are not offset and are arranged substantially in one line.

### LIST OF REFERENCE SIGNS

1 Power tool
2 Housing of the power tool
2a First end of the housing of the power tool
2b Second end of the housing of the power tool
3 Tool fitting
4 Handle
4a First end of the handle
4b Second end of the handle
5 Activation switch
6 Interface apparatus
6a First connecting element of the interface apparatus
6b Second connecting element of the interface apparatus
6c Third connecting element of the interface apparatus
7 Rechargeable battery
8 Tool
9 Battery housing
9a Front side of the battery housing
9b Rear side of the battery housing
9c Left-hand side wall of the battery housing
9e Top side of the battery housing
9f Underside of the battery housing
10 Connection apparatus
11 Energy storage cell
12 Control apparatus
13 Holding and receiving apparatus
13a First connection element
13b Second connection element
13c Third connection element
14a First terminal
14b Second terminal
14c Third terminal
15a First blade
15b Second blade
15c Third blade
16a First chamber
16b Second chamber
17a First end of a chamber
17b Second end of a chamber
18a First opening of a chamber
18b Second opening of a chamber
19a First compensating element
19b Second compensating element
20 First end of a compensating element
21 Second end of a compensating element
22a First connecting line
22b Second connecting line
22c Third connecting line
30 Connecting element
30a First end of the connecting element
30b Second end of the connecting element
30c Center of the connecting element
31a First lateral aperture
31b Second lateral aperture

What is claimed is:

1-3. (canceled)

4. A rechargeable battery comprising:
at least one energy storage cell; and
a connection apparatus for releasably connecting the rechargeable battery to a power tool, the connection apparatus including first, second and third connectors, and also including a holding and receiving apparatus for at least partially receiving the first, second and third connectors, wherein the first and second connectors are connected to the holding and receiving apparatus by at least one compensator in such a way that a relative movement in at least one direction between the first and second connectors and the holding and receiving apparatus (13) can be compensated for, and wherein the first and second connectors are connected to the third connector in such a way that a relative movement in at least one direction between the third connector and the holding and receiving apparatus can be compensated for.

5. The rechargeable battery as recited in claim 4 wherein the holding and receiving apparatus includes elongated first and second elongate chambers, each of the first and second connection elements positionable into the chambers with an associated compensator of the at least one compensator so that the first and second connection elements are movable reversibly in a direction relative to the respective first or second chamber via the associated compensator.

6. The rechargeable battery as recited in claim 4 wherein a connecting end of the third connector is are arranged offset from connecting ends of the first and second connectors, in at least one plane.

7. The rechargeable battery as recited in claim 4 wherein the rechargeable battery is a releasable energy supply for the power tool.
